(19) United States
(12) Patent Application Publication
(10) Pub. No.: US 2009/0038190 A1
(43) Pub. Date: Feb. 12, 2009

(54) DOOR OPENING INDICATOR DEVICE

(76) Inventor: Fernando OYARZUN SCHOLTBACH, Puerto Montt (CL)

Correspondence Address: HAMRE, SCHUMANN, MUELLER & LARSON, P.C., P.O. BOX 2902, MINNEAPOLIS, MN, 55402-0902, US

(21) Appl. No.: 12/248,419

(22) Filed: Oct. 9, 2008

Related U.S. Application Data
(63) Continuation of application No. PCT/ES2007/070073, filed on Apr. 11, 2007.

(30) Foreign Application Priority Data
Apr. 11, 2006 (CL) 821-2006

(51) Int. Cl. G09F 7/00

(52) U.S. Cl. 40/584

(57) ABSTRACT

A door opening indicator device comprising a signaler that uses a color code based on the color red and the color green for an anticipated arrangement of people accessing through them.

### FIELD OF THE INVENTION

The present disclosure relates to signposting for people's transit field, specifically to a door opening direction's indicator for an orderly access through them, by a color code.

### PREVIOUS ART DESCRIPTION

Today it has become essential the signposting for the behavior and working of various systems that are often around us and this signing must be above the language barrier or the understanding of the local language. It is with that in mind that many signaling devices use drawings to show escape routes in buildings such as hotels, airports, cinemas, malls, etc. or other emergency and/or warning and/or information symbols.

The symbol or figure language has a universal understanding, and as such it is used worldwide.

Another form of worldwide language is the information that can be given by using determined colors, associated or not with lights, and it is widely used on road signposts such as stoplights. In fact, the colors used for that have been standardized: For example, red for stopping or danger (forbidden) and green for passing o free (allowed).

An example of the latter can be found on the patent Document WO 01/71101, titled “Boarding hall call registration methods and its device” (Yoshida and others), which describes an access hall for a series of elevators, where there is a number and color indicator panel for each elevator, wherein each elevator also has its number and color laid out on top of its doors. The indicator panel provides buttons that can be lighted for each elevator and next to each button an assigned sector's indicator light. When a passenger wants to go to a floor on sector 1, he presses the button that corresponds to the sector, which is identified and transmitted to a sector indication's control. When the sector entry is registered, the pressed button lights up. When an elevator is assigned to sector 1, and indicator corresponding to sector 1 lights up and simultaneously the indicator on top of the elevator's door also lights up.

For the particular case of doors, and giving information respecting the opening direction of them in the case of swinging doors, it is used a sign at a medium height with a word in one language at most in two languages, that indicates if people has to pull or push for opening said door, which is comprehensible for people that knows the language in question.

The same happens for automatic swinging or sliding doors that use signs with words such as “entrance” or “exit”, because the have a proximity sensor, which makes the door work, only at one side of them.

On the previous cases the supplied information is not of use for everyone that needs to transit through the doors, for example, for those that do not know the language.

Because of the latter it is provided a door opening direction's indicator for an anticipated arrangement of the people accessing through them, by means of a Color code, using the colors red and green, widely known in the world, which indicate in a quick and precise manner the transit through them.

### BACKGROUND OF THE INVENTION

The development of the present invention was born upon the observance of the inefficiencies of people's transit through doors, when the existence of signaling that does not supply the necessary information for a safe and fluid transit through the doors was proved, we refer to the signposts that indicate the following texts: “tire-empuje/push-pull”.

Otherwise, there is no globally accepted and acknowledged signaling that adds its uniformity value.

The signaling that is used at the present time possesses serious limitations that reduce its efficiency; some of them are among the following:
The text “Push” indicated on the doors does not allow informing if these doors can be pushed by those who use the door on the opposite direction, situation that carries a risk of accident for who tries to operate in opposite direction within little gap of time. The described situation means that the current signaling can not inform when a door operates in both ways with a 180° swing.
The current signaling does not incorporate among its codes the possibility of informing when a door is blocked. This case is recurrently found in doors that are set consecutively with the finality of protecting or stopping the heat or air conditioning from escaping the place. The presence of blocked doors without information relative to its way of operating means permanent tries from people trying to open them, that produces discomfort and inefficiencies that are expressed a time net losses, losses that measured in global terms mean, surely, thousands of hour/man/year, economically quantifiable. To the cost previously described must be added the costs of accidents that are caused by a seriously limited signaling.
When the doors have a sing with the word “Pull” on it, it is not possible to determine if those that open it from the opposite direction can only push it or pull it, this last situation being a door with a 180° swing.
The current signaling and signposts are not able to deliver a 100% of the necessary information to make a safe and fluid passage through the doors, every time it is not among its codes to signal how the doors are operated from the opposite direction that they are being used.
The current signaling imposes idiomatic barriers that if added to the previously described deficiencies make it a product undervalued by the global community.

The present disclosure is born from the search for a logical formulation that allows conceiving a practical application that surpasses the detected deficiencies.

A invention patent documents search was performed on the main world's databases like the EP (European Patent Office), US (United States Patent and Trademark Office) and DPI (Industrial Property Department in Chile), said search meant the analysis of more than 1000 documents and no patents similar to what is being developed here were found.

One of the main virtues of the developed device, relates to the anticipated delivery (at a minimum distance of approximately 4 to 5 meters before contacting the doors) of a 100% of the information needed to know the full operation of the doors, from the direction they are being used, but also from the perspective of the people that uses them from the opposite direction. The latter means that the device gives information about what the door can do from the direction that it is being used, and simultaneously it is able to supply information pertaining the way these doors can be operated by those that use them from the opposite direction, surpassing the usefulness of the current device also known as the signs “push/pull” or “tire/empuje”.

What was just mentioned allows for reducing in a substantial way the risks of accidents caused by the lack of information, and enhancing the average speed for making a safe and fluid passage through these doors.

An evident advantage of the disclosure corresponds to the important time saving that it is achieved by people on their pas through the doors, by avoiding the current inefficiencies caused by an inefficient or inexistent signaling.

Globally the time savings expressed in hour/man/year can reach amounts of numerous economical resources.

### BRIEF DESCRIPTION OF THE FIGURES

FIG. 1 shows a top view of four doors with a first color code modality.

FIG. 2 shows a top view of the opening of the doors according to FIG. 1.

FIG. 3 shows a top view of four doors with a second color code modality.

FIG. 4 shows a top view of the opening of the doors according to FIG. 3.

FIGS. 5a and 5b show respectively perspective views of another embodiment of the invention for one door and two doors.

### DETAILED DESCRIPTION OF A PREFERRED EMBODIMENT

The present disclosure provides a general door opening direction's indicator, of manual swinging doors using a color code based on the red color and the green color.

Its design corresponds to a card that must be installed on each door on both sides, in the superior and opposite to the hinges part of the door, this design has two converging arrows drew in three dimensions, disposed in such way that the first arrow, if the door can only be pushed, must be green, and the second arrow red and if the door can only be pulled for its opening, the first arrow must be red and the second arrow must be green colored, the next two options correspond to blocked doors, in which case both arrows color must be red, on the other hand if the door operates in both ways (180° swinging doors), the first and second arrows color must be green, (see drawings).

In this way the user anticipates the working of a series of doors that are in sequence, as always happens in places that double doors are needed for a more suitable thermal insulation, e. i., places where is needed to maintain a temperature, for example to make the air conditioning, or heating, more efficient in a place in comparison to the exterior.

Another advantage of this disclosure is that it avoids displeasure and bad humor to the people that to make their way through the doors chose doors that are currently blocked, because the current devices “push-pull” are not meant to inform of this situation. The disclosure that has being developed allows avoiding accidents that many times can be really serious.

As it was mentioned before, the indicator of the present disclosure breaks the language barrier by using colors to indicate the way that the doors operate, and it might have an easy to understand global application.

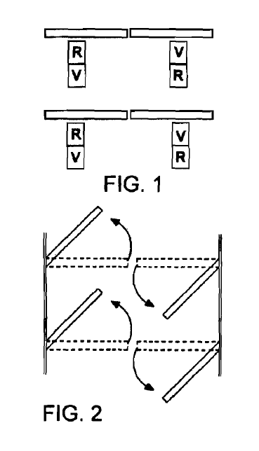

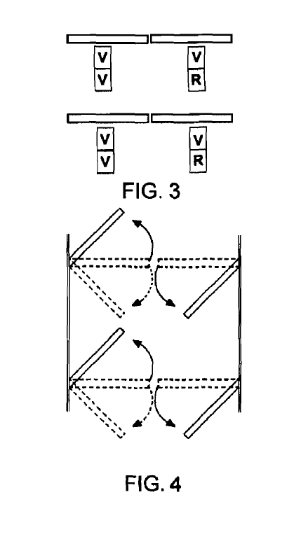

The way to implement the door opening indicator is through a card with 2 arrows drew tri-dimensionally, placed in the superior part of the doors, on the side opposite to its support (the hinges), that show the doors operation from the front side and the reverse side, being the lower arrow the one that indicates the doors operation from the front and the upper arrow the one that indicates the doors operation from behind. The latter is well explained by FIGS. 1 and 3 showing the code for a door that comprises two colors, one for the front and one from the back of the door, wherein “R” means red and “V” means green, in the Figures.

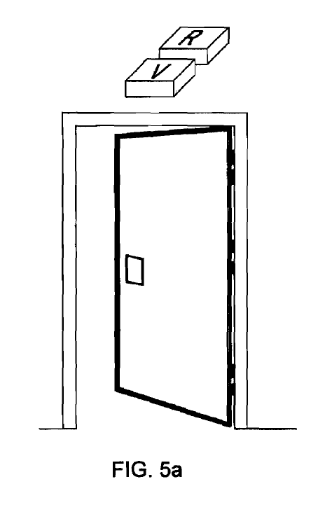

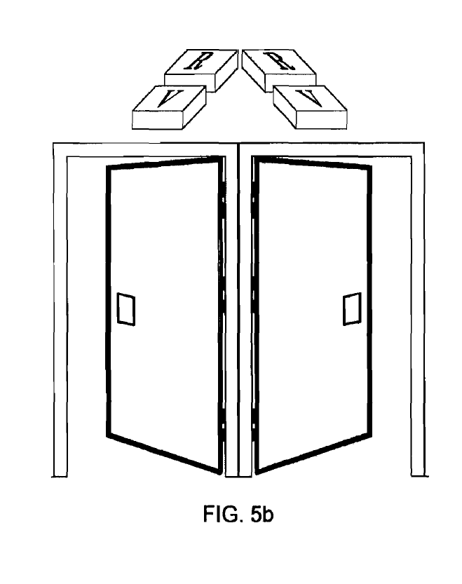

Another embodiment of the disclosure provides a flat sign in an indicator's perspective view as it is shown by FIG. 5a for a door or FIG. 5b for two doors, where it is clear that the perspective is from the front to the back of the door.

In yet another embodiment of the disclosure, the door opening indicator is a luminous device of the respecting color, wherein a luminous source of the color is placed on top of the door at both sides of it.

In another aspect of the disclosure the indicator is a panel where are disposed the color arrangement for the doors through luminous sources. The next Table shows a list of possible ways for functioning of two doors standing one next to the other.

TABLE
Color code list for different ways of
operation in the opening of doors.

| | LEFT | RIGHT |
|---|---|---|
| | DOOR | DOOR |
| 1 | R | R |
| | V | V |
| 2 | V | V |
| | R | R |
| 3 | R | V |
| | R | V |
| 4 | V | R |
| | V | R |
| 5 | R | V |
| | V | R |
| 6 | V | R |
| | R | V |
| 7 | R | V |
| | R | R |
| 8 | R | R |
| | R | V |
| 9 | R | R |
| | V | R |
| 10 | V | R |
| | R | R |
| 11 | V | R |
| | V | V |
| 12 | V | V |
| | V | R |
| 13 | R | V |
| | V | V |
| 14 | V | V |
| | R | V |

### Example of an Application

An example of an application is shown on FIG. 1, wherein the door opening indicator has a configuration allowing the opening of the doors as presented in FIG. 2. Meanwhile another application example is shown in FIG. 3 possessing two of its four doors allowing for opening in both ways and directions of the doors, as it is shown in FIG. 4.

1. A door opening indicator device, wherein it comprises a signaler that uses a color code based on the color red and the color green for an anticipated arrangement of the people's access through them.
When the first arrow's color is green it means PUSH.
When the second arrow's, drew in opposite direction, color is green it means PULL.
When the first arrow's color is red it means DO NOT PUSH.
When the second arrow's, drew in opposite direction, color is red it means DO NOT PULL.

2. The door opening indicator device according to claim 1, wherein the background's color is metallic grey.

3. The door opening indicator device according to claim 1, wherein said signaler is presented in a tri-dimensional way.

4. The door opening indicator device according to claim 1, wherein said signaler is on each side of the doors.

5. The door opening indicator device according to claim 1, wherein the doors are manual doors.

6. The door opening indicator device according to claim 1, wherein when the first arrow in perspective is green and the second is green the door is a 180° (or more) swinging door or a door that opens both ways.

7. The door opening indicator device according to claim 1, wherein the first arrow in perspective is red and the second arrow in perspective is green, the door can only be pulled to open it.

8. The door opening indicator device according to claim 1, wherein the first arrow in perspective is red and the second arrow in perspective is red the door is blocked.

9. The door opening indicator device according to claim 1, wherein the first arrow in perspective is green and the second arrow in perspective is red, the door can only be pushed to open it.
